(19) United States
(12) Patent Application Publication
(10) Pub. No.: US 2004/0148455 A1
(43) Pub. Date: Jul. 29, 2004

(54) Method and apparatus for passively recording product quality, employment and reliability

(76) Inventors: John W. Normand, Nashua, NH (US); Jonathan F. Morse, Wilton, NH (US); David C. Packard, Merrimack, NH (US)

Correspondence Address: BAE SYSTEMS INFORMATION AND, ELECTRONIC SYSTEMS INTEGRATION INC., 65 SPIT BROOK ROAD, P.O. BOX 868 NHQ1-719, NASHUA, NH, 03061-0868, US

(21) Appl. No.: 10/687,405

(22) Filed: Oct. 15, 2003

Related U.S. Application Data
(60) Provisional application No. 60/419,060, filed on Oct. 15, 2002.

(51) Int. Cl. G06F 13/00

(52) U.S. Cl. 711/100

(57) ABSTRACT

A method for tracking and recording metric parameters in a product item comprising the steps of positioning an Electrically Erasable Programmable Read Only Memory (EEPROM) Chip in the item; automatically tracking and recording all parameters in the EEPROM; and reading said parameters recorded into a database.

### RELATED APPLICATIONS

This application claims the benefit of U.S. Provisional Application No. 60/419,060, filed Oct. 15, 2002

### BACKGROUND OF INVENTION

1. Field of the Invention

The present invention relates to data processing systems for use in vehicles. More particularly, the present invention relates to data processing systems for use in vehicles which are designed to evaluate, monitor, indicate, track, or record the performance, operating condition, or servicing need of a vehicle.

2. Brief Description of Prior Developments

The tracking and recording of product metrics is a problem facing both the military and industrial marketplace. Products are routinely rated by how long they are in use without failure, how long they can be stored without failure, and what level of use they can withstand without failure. There are many different maintenance and logistics databases currently in use that require human intervention and fastidious attention. These databases require many man-hours to track quality, employment and reliability without adding any value to the quality of the product. This effort would be much better spent on other endeavors; however, the need for the data is unquestioned.

### SUMMARY OF THE INVENTION

The addition of an Electrically Erasable Programmable Read Only Memory (EEPROM) Chip or other nonvolatile memory device into products will solve this problem by automatically tracking and recording all required parameters. These data products would be updated continuously until the item is removed from service. When the item is received at the maintenance facility (or Depot) the data from the chip will be read into a single database that track the metrics for that product.

### BRIEF DESCRIPTION OF THE DRAWING

The present invention is further described with reference to the accompanying drawing wherein:

FIG. 1 is a schematic diagram on an EEPROM chip which may be used in a preferred embodiment of the present invention;

FIG. 2 is a schematic flow diagram illustrating a preferred embodiment of the method of the present invention.

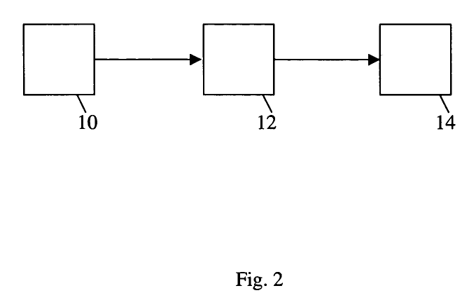

### DETAILED DESCRIPTION OF THE PREFERRED EMBODIMENT

The method and apparatus of the present invention may be used in replaceable components of air, land, and sea vehicles for recording specific data relative to vehicle maintenance which may vary from trip to trip. This data may include installed time, hours of use, operating conditions, numbers of uses, and replacement history.

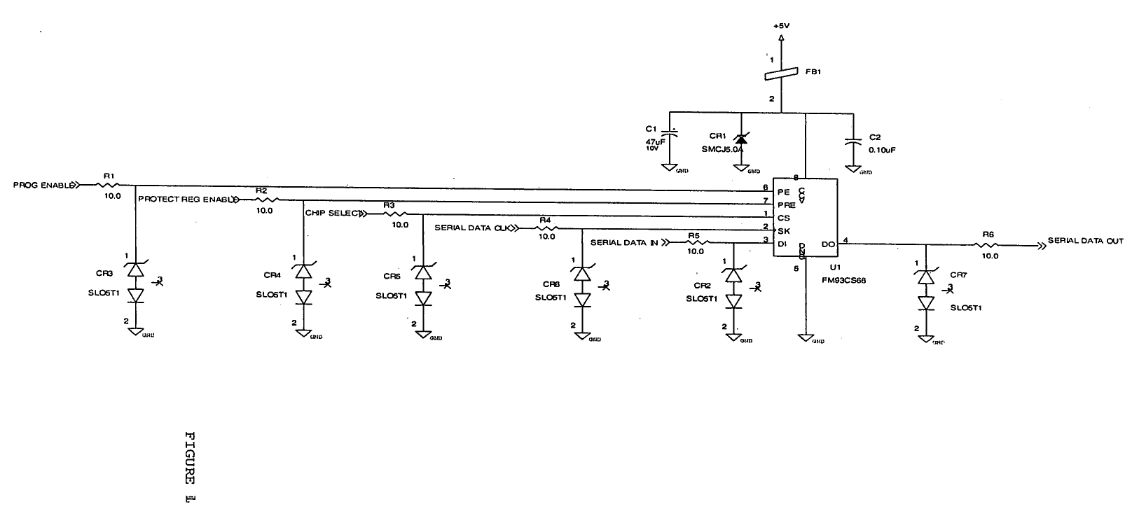

Referring to FIG. 1, an Electrically Erasable Programmable Read Only Memory (EEPROM) Chip as is shown in FIG. 1 is positioned in a vehicle at numeral 10. At numeral 12 all parameters in the EEPROM are automatically tracked and recorded. At numeral 14 all recorded parameters are then recorded into a database.

It will be appreciated that the components essentially track themselves. The user no longer has to track installed time, hours of use, operating conditions, numbers of uses, and replacement history of the components. This data is automatically tracked, thus resulting in reliability data.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for tracking and recording metric parameters in a product item comprising the steps of:
(a) positioning an Electrically Erasable Programmable Read Only Memory (EEPROM) Chip in the item;
(b) automatically tracking and recording all parameters in the EEPROM; and
(c) reading said parameters recorded in step (b) into a database.
